(19) United States
(12) Patent Application Publication
(10) Pub. No.: US 2026/0070420 A1
(43) Pub. Date: Mar. 12, 2026

(54) VEHICLE DISPLAY DEVICE, METHOD OF CONTROLLING VEHICLE DISPLAY DEVICE, AND STORAGE MEDIUM

(71) Applicant: HONDA MOTOR CO., LTD., Tokyo (JP)

(72) Inventor: Shinichi Kikuchi, Tokyo (JP)

(21) Appl. No.: 19/310,070

(22) Filed: Aug. 26, 2025

(30) Foreign Application Priority Data
Sep. 9, 2024 (JP) 2024-155064

(51) Int. Cl. B60K 35/81; B60K 35/22; B60K 35/29; H04N 21/414; H04N 21/45

(52) U.S. Cl. CPC B60K 35/81; B60K 35/22; B60K 35/29; H04N 21/41422; H04N 21/4532

(57) ABSTRACT

A vehicle display device includes: a display control unit configured to recommend content by displaying the content available in a vehicle by a display unit installed inside the vehicle; a passenger detection unit configured to detect a passenger riding in the vehicle; and a storage unit configured to store preference information indicating a preference of the content for each passenger of the vehicle, and the display control unit varies a display mode of the content depending on whether or not the preference information corresponding to the passenger detected by the passenger detection unit is stored in the storage unit.

### INCORPORATION BY REFERENCE

The present application claims priority under 35 U.S.C. § 119 to Japanese Patent Application No. 2024-155064 filed on Sep. 9, 2024. The content of the application is incorporated herein by reference in its entirety.

### BACKGROUND OF THE INVENTION

### Field of the Invention

The present invention relates to a vehicle display device, a method of controlling the vehicle display device, and a storage medium.

### Description of the Related Art

Conventionally, it is known to recommend content to a passenger inside a vehicle. For example, Japanese Patent Laid-Open No. 2019-109725 discloses technology of recommending content of a preference shared by a target user seated in a target seat and another user seated in another seat different from the target seat.

However, passengers of a vehicle may include a passenger whose content preference is unknown. Therefore, it cannot be said unconditionally that content of a common preference should be recommended, and there is room for improvement with respect to appropriate recommendation of content.

The present invention is implemented in consideration of the circumstances described above, and an object thereof is to appropriately recommend content to passengers of a vehicle.

### SUMMARY OF THE INVENTION

One aspect of the present invention is a vehicle display device including: a display control unit configured to recommend content by displaying the content available in a vehicle by a display unit installed inside the vehicle; a passenger detection unit configured to detect a passenger riding in the vehicle; and a storage unit configured to store preference information indicating a preference of the content for each passenger of the vehicle, and the display control unit varies a display mode of the content depending on whether or not the preference information corresponding to the passenger detected by the passenger detection unit is stored in the storage unit.

According to one aspect of the present invention, content can be appropriately recommended to passengers of a vehicle.

### BRIEF DESCRIPTION OF THE DRAWINGS

FIG. 1 is a diagram illustrating a configuration of a content distribution system;

FIG. 2 is a diagram illustrating a configuration of a vehicle display device;

FIG. 3 is a diagram illustrating an example of a first recommendation screen;

FIG. 4 is a diagram illustrating an example of a second recommendation screen;

FIG. 5 is a flowchart illustrating an operation of the vehicle display device;

FIG. 6 is a flowchart illustrating the operation of the vehicle display device;

FIG. 7 is a diagram illustrating the configuration of the content distribution system; and

FIG. 8 is a diagram illustrating the configuration of the vehicle display device.

### DETAILED DESCRIPTION OF THE INVENTION

### 1. First Embodiment

First, with reference to the drawings, the first embodiment will be described.

### [1-1. Configuration of Content Distribution System]

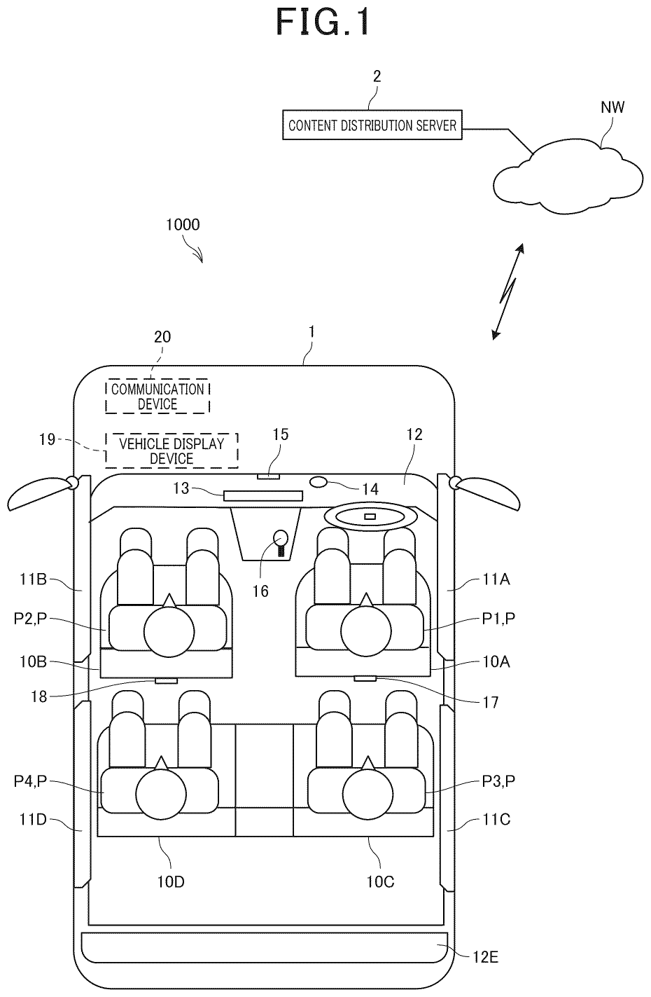

FIG. 1 is a diagram illustrating a configuration of a content distribution system 1000 according to the first embodiment.

The content distribution system 1000 is a system that distributes content to a vehicle 1. Examples of the content distributed by the content distribution system 1000 include movies, still images, and music. The content distributed by the content distribution system 1000 is the content available inside the vehicle 1. Note that the content that is available inside the vehicle 1 is the content that can be output into an interior of the vehicle 1.

As illustrated in FIG. 1, the content distribution system 1000 includes the vehicle 1 and a content distribution server 2.

Before describing the vehicle 1, the content distribution server 2 will be described. The content distribution server 2 is a server device that distributes content. The content distribution server 2 is connected to a network NW, and communicates with the vehicle 1. The network NW is a communication network formed of a public network, an exclusive line, and other communication circuits or the like. The content distribution system 1000 may include the content distribution server 2 for each content distribution source. In addition, the content distribution server 2 may be a server device that integrally distributes the content distributed by a plurality of content distribution sources to the vehicle 1.

The vehicle 1 illustrated in FIG. 1 is a four-wheel vehicle. The vehicle 1 includes a driver's seat 10A, a front passenger seat 10B, a rear right seat 10C, and a rear left seat 10D. FIG. 1 illustrates a situation where a passenger P1 who is a driver is seated in the driver's seat in the vehicle 1. In addition, FIG. 1 illustrates a situation where a passenger P2 who is a fellow passenger is seated in the front passenger seat 10B in the vehicle 1. Further, FIG. 1 illustrates a situation where a passenger P3 who is a fellow passenger is seated in the rear right seat 10C in the vehicle 1. Further, FIG. 1 illustrates a situation where a passenger P4 who is a fellow passenger is seated in the rear left seat 10D in the vehicle 1.

The vehicle 1 includes a right front door 11A, a left front door 11B, a right rear door 11C, a left rear door 11D, and a tailgate 11E. Opening the right front door 11A, the left front door 11B, the right rear door 11C, and the left rear door 11D makes it possible to get in and out of an interior space of the vehicle 1. The tailgate 11E opens and closes a trunk of the vehicle 1.

The vehicle 1 includes a dashboard 12. On the dashboard 12, a touch panel 13 and a speaker 14 are installed. The touch panel 13 is formed by superimposing or integrating a display panel that displays characters and images and a touch sensor that detects contact to the display panel.

The speaker 14 outputs sound to the interior space of the vehicle 1. An installation position and the number of the speakers 14 can be arbitrarily changed.

The touch panel 13 is an example of a “display unit”.

In the interior of the vehicle 1, a camera 15 that photographs the interior of the vehicle 1 is installed. A photographing range of the camera 15 is set to a range where it is possible to photograph the passenger P seated in the driver's seat 10A and the passenger P seated in the front passenger seat 10B. More specifically, the photographing range of the camera 15 is set to the range where it is possible to photograph heads (including faces) of the two passengers P.

The vehicle 1 includes a shift lever 16 installed near the driver's seat 10A.

A camera 17 is installed in the interior of the vehicle 1. The camera 17 is installed on a back surface of the driver's seat 10A for example, and photographs the passenger P seated in the rear right seat 10C. A photographing range of the camera 17 is set to a range where it is possible to photograph the passenger P seated in the rear right seat 10C. More specifically, the photographing range of the camera 17 is set to the range where it is possible to photograph the head (including the face) of the passenger P seated in the rear right seat 10C.

A camera 18 is installed in the interior of the vehicle 1. The camera 18 is installed on a back surface of the front passenger seat 10B for example, and photographs the passenger P seated in the rear left seat 10D. A photographing range of the camera 18 is set to a range where it is possible to photograph the passenger P seated in the rear left seat 10D. More specifically, the photographing range of the camera 18 is set to the range where it is possible to photograph the head (including the face) of the passenger P seated in the rear left seat 10D.

The vehicle 1 includes a vehicle display device 19. The vehicle display device 19 outputs the content distributed by the content distribution server 2 by at least one of the touch panel 13 and the speaker 14. The vehicle display device 19 displays various kinds of information by the touch panel 13. In the present embodiment, the vehicle display device 19 displays a recommendation screen G that recommends the content which can be distributed by the content distribution server 2, in other words, the recommendation screen G that recommends the content available in the vehicle 1. Note that the vehicle display device 19 outputs the content selected on the recommendation screen G in the vehicle 1.

The vehicle 1 includes a communication device 20. The communication device 20 includes hardware according to a predetermined communication standard such as a wireless communication circuit, and communicates with the content distribution server 2 connected to the network NW.

### [1-2. Configuration of Vehicle Display Device]

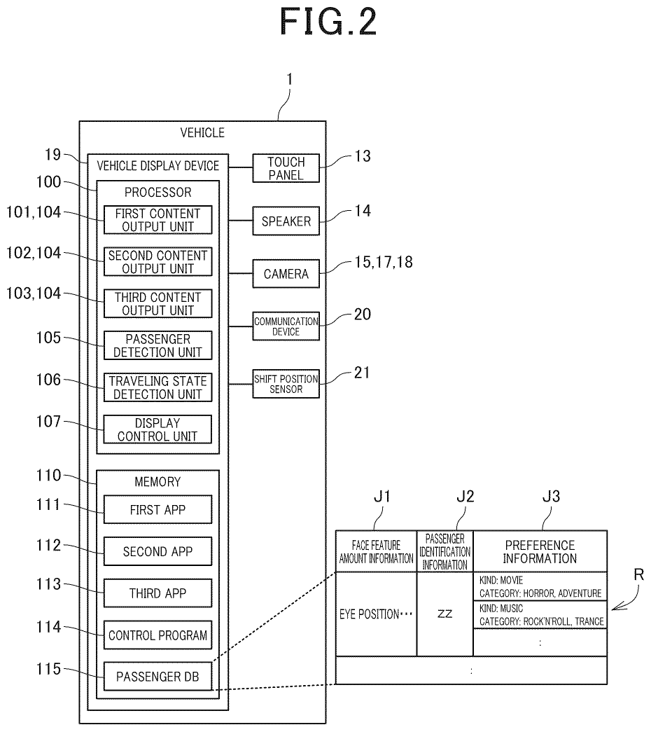

Next, with reference to FIG. 2, the configuration of the vehicle display device 19 will be described.

FIG. 2 is a diagram illustrating the configuration of the vehicle display device 19.

To the vehicle display device 19, the touch panel 13, the speaker 14, the camera 15, the camera 17, the camera 18, the communication device 20, and a shift position sensor 21 are connected. Note that devices connected to the vehicle display device 19 are not limited to these devices and devices of other kinds may be connected further.

The touch panel 13 displays various kinds of information according to control of the vehicle display device 19.

The speaker 14 outputs various kinds of sound according to the control of the vehicle display device 19.

The cameras 15, 17, and 18 perform photographing in a predetermined cycle, and output photographed images obtained by the photographing to the vehicle display device 19.

The communication device 20 communicates with the vehicle display device 19 and the content distribution server 2.

The shift position sensor 21 detects a shift position of the shift lever 16 provided in the vehicle 1. The shift position is, for example, P (parking) used when stopping or parking the vehicle, R (reverse) used when moving backwards, N (neutral), and D (drive) used when traveling, or the like.

The vehicle display device 19 includes a processor 100 such as a CPU (Central Processing Unit) and an MPU (Micro Processor Unit), a memory 110, and an interface circuit for connecting other devices and sensors.

The memory 110 is an example of a “storage unit”.

The memory 110 is a storage device that stores programs and data. The memory 110 stores a first APP 111, a second APP 112, a third APP 113, a control program 114, a passenger DB (database) 115, and data processed by the processor 100. The memory 110 includes a nonvolatile storage area. In addition, the memory 110 may include a volatile storage area and configure a work area of the processor 100. The memory 110 is formed of a ROM (Read Only Memory) and a RAM (Random Access Memory) for example.

The control program 114 is an example of a “program”.

The first APP 111 is an application program for utilizing content distributed by one content distribution source.

The second APP 112 is an application program for utilizing content distributed by a content distribution source different from that of the first APP 111.

The third APP 113 is an application program for utilizing content distributed by a content distribution source different from that of the first APP 111 and the second APP 112.

The control program 114 is a program that makes the processor 100 function as functional units to be described later.

The passenger DB 115 is a database having one record R for each passenger P. One record R includes face feature amount information J1, passenger identification information J2, and one or more pieces of preference information J3. The record R is created in advance and is registered in the passenger DB 115. Note that the record R has one piece of preference information J3 for each kind of content preferred by the passenger P. The kind of the content will be described later.

The face feature amount information J1 is information that indicates a face feature amount of the passenger P. The face feature amount indicates a feature amount of a face formed of a plurality of items such as a position of a feature point of an eye, a position of a feature point of a nose, a position of a feature point of a mouth, and a size of a face area.

The passenger identification information J2 is information that identifies the passenger P, and is, for example, information indicating a name, information indicating a given name in a family structure, and information indicating a uniquely allocated number.

The preference information J3 is information that indicates a preference of content of the passenger P. The preference information J3 is information that indicates the kind of content preferred by the passenger P. Further, the preference information J3 is also information that indicates one or more categories of content preferred by the passenger P.

The kinds of content indicate kinds such as movies, moving images, still images, and music.

The category of content is a finer classification than the kind of content. In a case of movies, the categories of content are action movies, adventure movies, animation movies, documentary movies, horror movies, and the like. In the case of music, the categories of content are rock‘n’roll, reggae, PHONK, trance, and the like. In the case of moving images, the categories of content are a distribution type, a merchandise introduction type, an entertainment type, a recitation type, and the like. Further, in the case of still images, the categories of content are Western painting, Oriental painting, and the like.

The processor 100 functions as a first content output unit 101 by reading and executing the first APP 111 stored in the memory 110.

The first content output unit 101 receives the content of the content distribution source corresponding to the first APP 111 from the content distribution server 2 via the communication device 20, and outputs the received content by at least one of the touch panel 13 and the speaker 14.

The processor 100 functions as a second content output unit 102 by reading and executing the second APP 112 stored in the memory 110.

The second content output unit 102 receives the content of the content distribution source corresponding to the second APP 112 from the content distribution server 2 via the communication device 20, and outputs the received content by at least one of the touch panel 13 and the speaker 14.

The processor 100 functions as a third content output unit 103 by reading and executing the third APP 113 stored in the memory 110.

The third content output unit 103 receives the content of the content distribution source corresponding to the third APP 113 from the content distribution server 2 via the communication device 20, and outputs the received content by at least one of the touch panel 13 and the speaker 14.

Hereinafter, the first content output unit 101, the second content output unit 102, and the third content output unit 103 are denoted by a reference numeral “104” and expressed as “content output units 104”, when not to be distinguished from each other.

The content output unit 104 receives content information together with content. The content information includes information indicating the kind of the content, information indicating the category of the content, and image data of an icon image IC. The icon image IC is an image for selecting the content to be output, and indicates contents (a title, for example) of the content by a picture, a photo, and characters.

The processor 100 functions as a passenger detection unit 105, a traveling state detection unit 106, and a display control unit 107 by reading and executing the control program 114 stored in the memory 110.

### [1-3. Configuration of Passenger Detection Unit]

The passenger detection unit 105 detects the passenger P of the vehicle 1.

In the present embodiment, the passenger detection unit 105 detects the passenger P based on the photographed images received from the cameras 15, 17 and 18. The passenger detection unit 105 detects an image of a face by a method of pattern matching or the like for each of the received photographed images. The passenger detection unit 105 detects the passenger P by detecting the image of the face.

When the image of the face is detected, that is, when the passenger P is detected, the passenger detection unit 105 calculates the face feature amount for each detected passenger P. Note that the face feature amount is calculated based on, for example, a size of the image of the face in the photographed image, the position of the feature point of the eye, the position of the feature point of the noise, and the position of the feature point of the mouth in the image of the face, or the like.

When the passenger P of the vehicle 1 is detected, the passenger detection unit 105 detects a seated position of the passenger P for each detected passenger P.

For example, when the image of the face is detected on a left side from a center in the photographed image of the camera 15, the passenger detection unit 105 detects the seated position of the passenger P corresponding to the image of the face as the driver's seat 10A.

In addition, for example, when the image of the face is detected on a right side from the center in the photographed image of the camera 15, the passenger detection unit 105 detects the seated position of the passenger P corresponding to the image of the face as the front passenger seat 10B.

Further, for example, when the image of the face is detected from the photographed image of the camera 17, the passenger detection unit 105 detects the seated position of the passenger P corresponding to the image of the face as the rear right seat 10C.

Further, for example, when the image of the face is detected from the photographed image of the camera 18, the passenger detection unit 105 detects the seated position of the passenger P corresponding to the image of the face as the rear left seat 10D.

The passenger detection unit 105 detects a state of the passenger P in a predetermined cycle for each detected passenger P.

In the present embodiment, the passenger detection unit 105 detects whether or not it is a predetermined state of not looking at the touch panel 13. Examples of the predetermined state include a sleeping state and a state of looking at something other than the touch panel 13. The passenger detection unit 105 detects a line of sight of the detected passenger P and an eye state of the passenger P in the predetermined cycle by technology of pattern matching or the like from the photographed images of the cameras 15, 17 and 18. Then, the passenger detection unit 105 detects that it is the predetermined state of not looking at the touch panel 13 when the line of sight of the detected passenger P is not in a direction of the touch panel 13 for a predetermined period or longer or when the eye state of the passenger P is a closed state for the predetermined period or longer. For the photographed image of each camera, the direction of the touch panel 13 is determined, and the passenger detection unit 105 performs the detection described above depending on whether or not the direction of the line of sight of the passenger P and the direction of the touch panel 13 coincide.

### [1-4. Configuration of Traveling State Detection Unit]

The traveling state detection unit 106 detects a traveling state of the vehicle 1. The traveling state detection unit 106 detects whether or not the vehicle 1 is traveling. For example, when the shift position sensor 21 detects R (reverse), N (neutral) or D (drive), the traveling state detection unit 106 detects that the vehicle 1 is traveling. Further, when the shift position sensor 21 detects P (parking), the traveling state detection unit 106 detects that the vehicle 1 is not traveling.

### [1-5. Configuration of Display Control Unit]

The display control unit 107 displays the recommendation screen G that recommends the content available inside the vehicle 1 by the touch panel 13. While details will be described later, the recommendation screen G displays the icon image IC for each piece of content. Note that one piece of content is, for example, a piece of music, one movie, one moving image, or one still image.

The display control unit 107 displays a first recommendation screen G1 as the recommendation screen G by the touch panel 13 in the case described below.

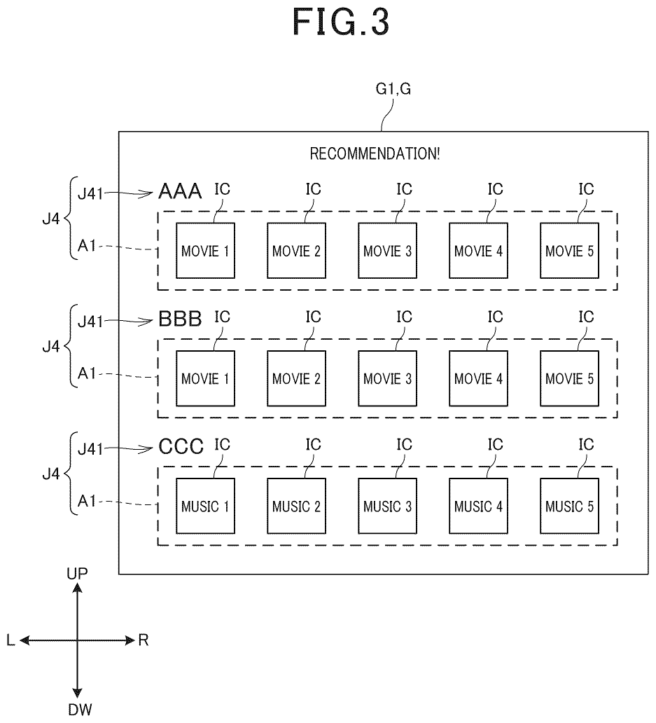

FIG. 3 is a diagram illustrating an example of the first recommendation screen G1.

In FIG. 3, an upward direction in the figure is indicated with a sign UP, a downward direction in the figure is indicated with a sign DW, a direction toward left in the figure is indicated with a sign L, and a direction toward right in the figure is indicated with a sign R. The four up, down, left, and right directions correspond to the four up, down, left, and right directions in the state of the passenger P who visually recognizes the recommendation screen G.

The first recommendation screen G1 is a screen that recommends the content to all the passengers P detected by the passenger detection unit 105. That is, the first recommendation screen G1 is not a screen that recommends the content to each passenger P detected by the passenger detection unit 105.

The first recommendation screen G1 includes first content related information J4 for each content distribution source. The first content related information J4 includes name information J41 and a list display area A1.

The name information J41 is information that indicates a name of the content distribution source.

The list display area A1 is an area that displays a list of the content distributed by the content distribution source indicated by the name information J41, and displays one icon image IC for one piece of the content.

While the list display area A1 illustrated in FIG. 3 is configured to display the plurality of icon images IC in a left-right direction in one row, the list display area A1 may be configured to display the plurality of icon images IC in the left-right direction in a plurality of rows. Further, the list display area A1 may be configured to, when a predetermined touch operation (a flick operation or a slide operation) is performed inside the list display area A1, display other icon images IC that have not been displayed before the predetermined touch operation is performed.

The first recommendation screen G1 illustrated in FIG. 3 is configured to recommend the content of the three content distribution sources on one screen. However, a screen configuration of the first recommendation screen G1 is not limited to the configuration illustrated in FIG. 3. For example, the first recommendation screen G1 may be formed of a plurality of screens and may be configured to recommend the content of one or more content distribution sources on one screen. In the case of this example, when the predetermined touch operation (the flick operation or the slide operation) is performed in an area other than the list display area A1 on the first recommendation screen G1, the first recommendation screen G1 switches the screen that recommends the content to the screen that recommends the content of another content distribution source.

In addition, the first recommendation screen G1 illustrated in FIG. 3 exemplifies the screen when the first APP 111, the second APP 112, and the third APP 113 are stored in the memory 110. That is, the first recommendation screen G1 illustrated in FIG. 3 exemplifies the screen when the three application programs for utilizing the content are installed in the memory 110. If four or more application programs are installed in the memory 110, the first recommendation screen G1 may be configured to recommend the content of the four or more content distribution sources on one screen, as illustrated in FIG. 3. Further, if four or more application programs are installed in the memory 110, the first recommendation screen G1 may be formed of a plurality of screens and configured to recommend the content of the one or more content distribution sources on one screen. In the case of this configuration, when the predetermined touch operation (the flick operation or the slide operation) is performed in an area other than the list display area A1 on the first recommendation screen G1, the first recommendation screen G1 switches the screen that recommends the content to the screen that recommends the content of another content distribution source.

Returning to description of the display control unit 107, the case where the display control unit 107 displays the first recommendation screen G1 will be described.

The display control unit 107 determines whether or not the preference information J3 corresponding to the passenger P is stored in the memory 110 for each passenger P detected by the passenger detection unit 105.

More specifically, the display control unit 107 of the present embodiment acquires the face feature amount from the passenger detection unit 105 for each passenger P, and determines whether or not the record R including the face feature amount with a concordance rate with the acquired face feature amount being a threshold or higher is present for each passenger P. Then, the display control unit 107 determines that the preference information J3 corresponding to the passenger P is stored when it is determined that the record R is present, and determines that the preference information J3 corresponding to the passenger P is not stored when it is determined that the record R is not present.

Then, when the passenger P for whom the preference information J3 is not stored in the memory 110 is included in the passengers P detected by the passenger detection unit 105, the display control unit 107 displays the first recommendation screen G1 by the touch panel 13.

When displaying the first recommendation screen G1, the display control unit 107 performs following processing for each content distribution source.

That is, the display control unit 107 selects a plurality of pieces of content received by the content output unit 104. Selection is made at random. Next, the display control unit 107 acquires the icon image IC from the content information for all the selected content. Then, the display control unit 107 generates the first content related information J4 including the list display area A1 where the acquired icon images IC are lined up and the name information J41, and includes the generated first content related information J4 in the first recommendation screen G1.

The display control unit 107 displays a second recommendation screen G2 by the touch panel 13 in the case described below.

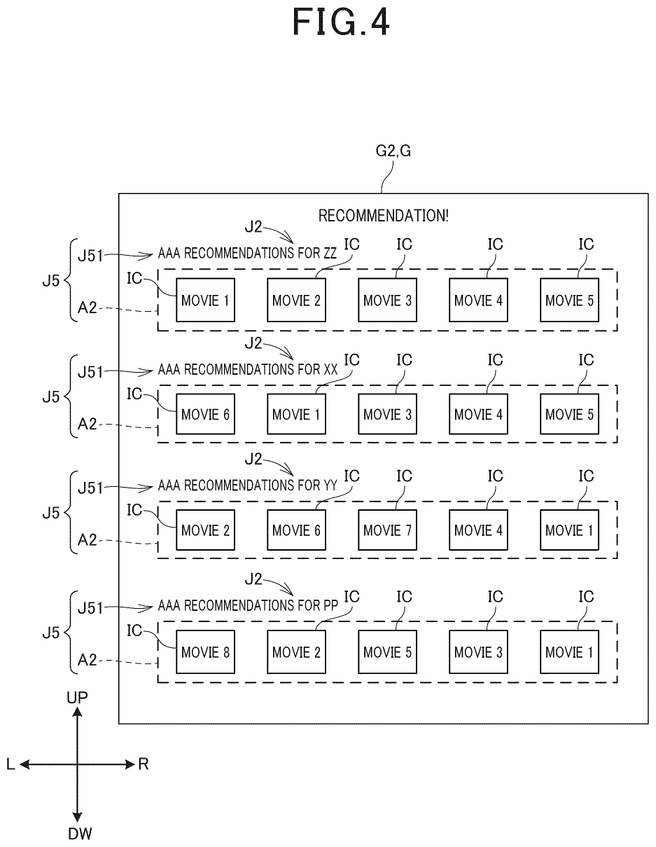

FIG. 4 is a diagram illustrating an example of the second recommendation screen G2.

In FIG. 4, an upward direction in the figure is indicated with a sign UP, a downward direction in the figure is indicated with a sign DW, a direction toward left in the figure is indicated with a sign L, and a direction toward right in the figure is indicated with a sign R. The four up, down, left, and right directions correspond to the four up, down, left, and right directions in the state of the passenger P who visually recognizes the recommendation screen G.

The second recommendation screen G2 is a screen that recommends the content to each passenger P who is detected by the passenger detection unit 105 and for whom the preference information J3 is stored in the memory 110.

The second recommendation screen G2 includes second content related information J5 for each passenger P who is detected by the passenger detection unit 105 and for whom the preference information J3 is stored in the memory 110.

The second content related information J5 includes recommendation destination information J51 and a list display area A2.

The recommendation destination information J51 is information that indicates a person to whom the content displayed in the corresponding list display area A2 is recommended, and includes the passenger identification information J2.

The list display area A2 is an area that displays a list of recommended content for one content distribution source, and displays one icon image IC for one piece of the content.

While the list display area A2 illustrated in FIG. 4 is configured to display the plurality of icon images IC in the left-right direction in one row, the list display area A2 may be configured to display the plurality of icon images IC in the left-right direction in a plurality of rows. Further, the list display area A2 may be configured to, when the predetermined touch operation (the flick operation or the slide operation) is performed inside the list display area A2, display other icon images IC that have not been displayed before the predetermined touch operation is performed.

The second recommendation screen G2 of the present embodiment includes a screen that displays the content for each passenger P for each content distribution source. That is, when there are a plurality of content distribution sources, the second recommendation screen G2 of the present embodiment is formed of a plurality of screens, and displays the content of one content distribution source on one screen. When the predetermined touch operation (the flick operation or the slide operation) is performed in an area other than the list display area A2 on the second recommendation screen G2, the second recommendation screen G2 switches the screen that recommends the content to the screen that recommends the content of another content distribution source.

When the plurality of passengers P are detected by the passenger detection unit 105, the second recommendation screen G2 displays the content based on display priority of the content. The display priority of the content is the priority for displaying the content. The display priority of the content is set for each passenger P. The display priority of the content is set based on the seated position of the passenger P and the traveling state of the vehicle 1.

When the traveling state of the vehicle 1 is not traveling, the display priority of the content is set as follows. That is, the display priority of the content for the passenger P in the driver's seat 10A is set to be higher than the display priority of the content for the passenger P in the front passenger seat 10B. In addition, the display priority of the content for the passenger P in the front passenger seat 10B is set to be higher than the display priority of the content for the passenger P in a rear seat (at least one of the rear right seat 10C and the rear left seat 10D).

When the traveling state of the vehicle 1 is traveling, the display priority of the content is set as follows. That is, the display priority of the content for the passenger P in the driver's seat 10A is set to be lower than the display priority of the content for the passenger P in the front passenger seat 10B and the passenger P in the rear seat. In addition, the display priority of the content for the passenger P in the front passenger seat 10B is set to be higher than the display priority of the content for the passenger P in the rear seat.

The second recommendation screen G2 displays the content at a higher rank for the passenger P with the higher display priority of the content on one screen regarding one content distribution source. Here, displaying at a higher rank means displaying at an upper position in an up-down direction of the recommendation screen G.

For example, when the passengers P1, P2, P3, and P4 are detected as illustrated in FIG. 1 and the vehicle 1 is not traveling, the second recommendation screen G2 displays the content for the passenger P1 above the content for the other passengers P, and displays the content for the passenger P2 above the content for the passengers P3 and P4 on one screen regarding one content distribution source. That is, in the case of this example, the second recommendation screen G2 displays the second content related information J5 of the passenger P1 above the second content related information J5 of the other passengers P, and displays the second content related information J5 of the passenger P2 above the second content related information J5 of the passengers P3 and P4.

Further, for example, when the passengers P1, P2, P3, and P4 are detected as illustrated in FIG. 1 and the vehicle 1 is traveling, the second recommendation screen G2 displays the content for the passenger P2 above the content for the passenger P3, and displays the content for the passenger P1 below the content for the other passengers P on one screen regarding one content distribution source. That is, in the case of this example, the second recommendation screen G2 displays the second content related information J5 of the passenger P2 above the second content related information J5 of the passenger P3, and displays the second content related information J5 of the passenger P1 below the second content related information J5 of the other passengers P.

Returning to the description of the display control unit 107, the case where the display control unit 107 displays the second recommendation screen G2 will be described.

When the preference information J3 of all the passengers P detected by the passenger detection unit 105 is stored in the memory 110, the display control unit 107 displays the second recommendation screen G2 by the touch panel 13.

In addition, when the state of the passenger P for whom the preference information J3 is not stored in the memory 110 is the predetermined state of not looking at the touch panel 13 after the first recommendation screen G1 is displayed, the display control unit 107 displays the second recommendation screen G2 by the touch panel 13.

When displaying the second recommendation screen G2, the display control unit 107 sets the display priority of the content for each passenger P who is detected by the passenger detection unit 105 and for whom the preference information J3 is stored in the memory 110.

Then, when the display priority of the content is set, the display control unit 107 executes the following processing for each passenger P who is detected by the passenger detection unit 105 and for whom the preference information J3 is stored in the memory 110.

That is, the display control unit 107 acquires the face feature amount from the passenger detection unit 105, specifies the record R including the face feature amount with the concordance rate with the acquired face feature amount being the threshold or higher from the passenger DB 115, and reads the preference information J3 from the specified passenger DB 115. Then, the display control unit 107 refers to the content information received by the content output unit 104 for each content distribution source, specifies one or more pieces of the content pertinent to the category of the content included in the read preference information J3, and determines the specified content as a display target. Next, the display control unit 107 acquires the icon image IC of the content that is the display target from the content information for each content distribution source. In addition, the display control unit 107 acquires the passenger identification information J2 from the specified record R. Then, the display control unit 107 generates the second content related information J5 using the acquired icon image IC and the passenger identification information J2 for each content distribution source.

When the second content related information J5 is generated for each passenger P who is detected by the passenger detection unit 105 and for whom the preference information J3 is stored in the memory 110, the display control unit 107 generates the second recommendation screen G2 where the second content related information J5 is arranged based on the set display priority of the content.

### [1-5. Operation of Vehicle Display Device]

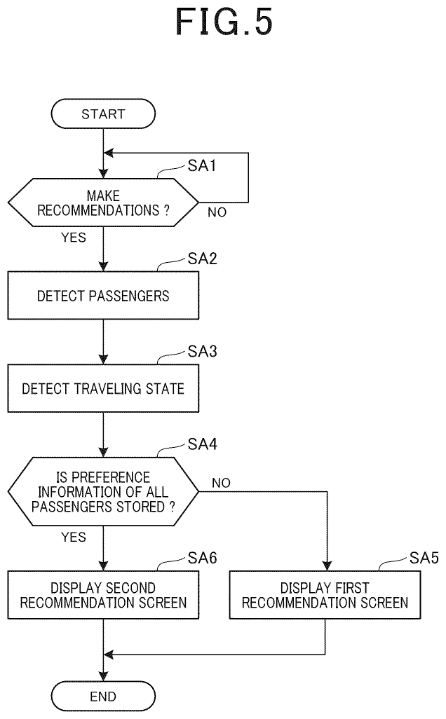

Next, with reference to FIG. 5, the operation of the vehicle display device 19 regarding content recommendation will be described.

FIG. 5 is a flowchart illustrating the operation of the vehicle display device 19.

The display control unit 107 determines whether or not to recommend the content (step SA1). For example, if the passenger P inputs an instruction to display a list of the content to the touch panel 13, the display control unit 107 makes an affirmative determination in step SA1.

If it is determined not to recommend the content (step SA1: NO), the display control unit 107 makes a determination in step SA1 again.

On the other hand, if the display control unit 107 determines to recommend the content (step SA1: YES), the passenger detection unit 105 detects the passengers P riding in the vehicle 1 (step SA2).

Next, the traveling state detection unit 106 detects the traveling state of the vehicle 1 (step SA3).

Note that a processing order of steps SA2 and SA3 may be reversed. Further, steps SA2 and SA3 may be simultaneously executed.

Next, the display control unit 107 determines whether or not the preference information J3 of all the passengers P detected in step SA2 is stored in the memory 110 (step SA4).

If it is determined that the preference information J3 of all the passengers P detected in step SA2 is not stored in the memory 110 (step SA4: NO), the display control unit 107 displays the first recommendation screen G1 by the touch panel 13 (step SA5).

When one icon image IC is selected by a touch operation on the first recommendation screen G1, the content output unit 104 outputs the content corresponding to the selected icon image IC. That is, if the content corresponding to the selected icon image IC is the content distributed by the first APP 111, the first content output unit 101 outputs the content corresponding to the selected icon image IC. In addition, if the content corresponding to the selected icon image IC is the content distributed by the second APP 112, the second content output unit 102 outputs the content corresponding to the selected icon image IC. Further, if the content corresponding to the selected icon image IC is the content distributed by the third APP 113, the third content output unit 103 outputs the content corresponding to the selected icon image IC.

On the other hand, if it is determined that the preference information J3 of all the passengers P detected in step SA2 is stored in the memory 110 (step SA4: YES), the display control unit 107 displays the second recommendation screen G2 by the touch panel 13 (step SA6).

When one icon image IC is selected by a touch operation on the second recommendation screen G2, the content output unit 104 outputs the content corresponding to the selected icon image IC.

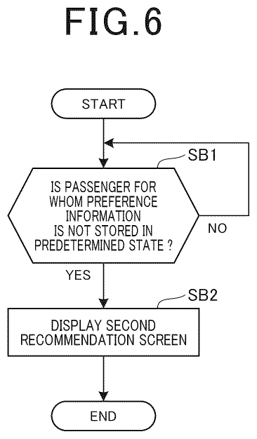

Next, with reference to FIG. 6, the operation of the vehicle display device 19 regarding the content recommendation will be described.

FIG. 6 is a flowchart illustrating the operation of the vehicle display device 19. The operation illustrated in FIG. 6 is the operation started with display of the first recommendation screen G1 by the touch panel 13 as a trigger.

The display control unit 107 determines whether or not the state of the passenger P for whom the preference information J3 is not stored in the memory 110 is the predetermined state of not looking at the touch panel 13 (step SB1).

The display control unit 107 makes a determination in step SB1 based on a detection result of the passenger detection unit 105.

If it is determined that the state of the passenger P for whom the preference information J3 is not stored in the memory 110 is not the predetermined state of not looking at the touch panel 13 (step SB1: NO), the display control unit 107 makes the determination in step SB1 again.

On the other hand, if it is determined that the state of the passenger P for whom the preference information J3 is not stored in the memory 110 is the predetermined state of not looking at the touch panel 13 (step SB1: YES), the display control unit 107 displays the second recommendation screen G2 by the touch panel 13 (step SB2).

### 2. Second Embodiment

Next, the second embodiment will be described.

In the description of the second embodiment, components same as the components of the first embodiment are denoted by the same reference signs and the detailed description is appropriately omitted.

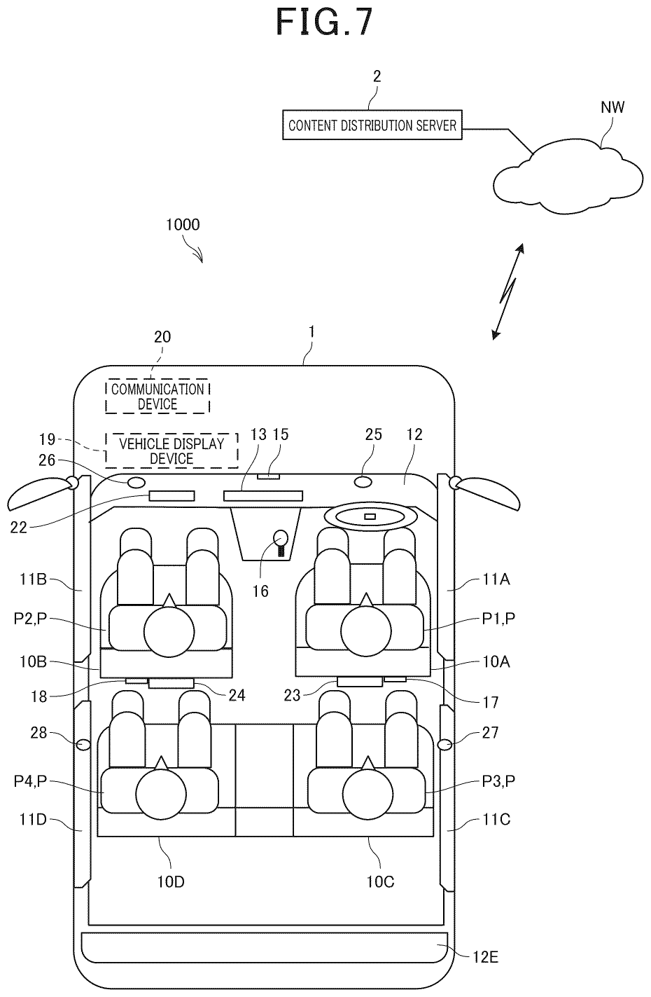

FIG. 7 is a diagram illustrating the configuration of the content distribution system 1000 according to the second embodiment.

As is clear from a comparison between FIG. 7 and FIG. 1, the vehicle 1 of the second embodiment includes touch panels 22, 23, and 24.

In addition, as is clear from the comparison between FIG. 7 and FIG. 1, the vehicle 1 of the second embodiment includes speakers 25, 26, 27, and 28.

The touch panels 22, 23, and 24 are examples of the “display unit”.

Each of the touch panels 22, 23, and 24 is formed by superimposing or integrating a display panel that displays characters and images and a touch sensor that detects contact to the display panel. The touch panel 22 is installed more on the side of the front passenger seat 10B than the touch panel 13 on the dashboard 12. The touch panel 23 is installed at a position to be visually recognized by the passenger P seated in the rear right seat 10C, on a back surface of the driver's seat 10A for example. The touch panel 24 is installed at a position to be visually recognized by the passenger P seated in the rear left seat 10D, on a back surface of the front passenger seat 10B for example.

The speaker 25 outputs sound to the passenger P seated in the driver's seat 10A. The speaker 26 outputs sound to the passenger P seated in the front passenger seat 10B. The speaker 27 outputs sound to the passenger P seated in the rear right seat 10C. The speaker 28 outputs sound to the passenger P seated in the rear left seat 10D. Note that installation positions of the speakers 25, 26, 27, and 28 are not limited to those in FIG. 7 and may be positions from which sound can be output to the passenger P seated in the corresponding seat.

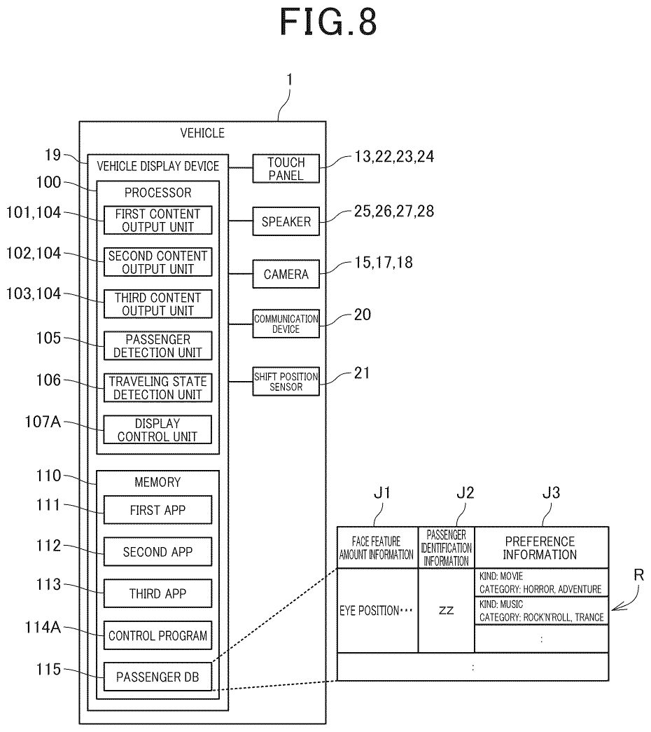

FIG. 8 is a diagram illustrating the configuration of the vehicle display device 19 according to the second embodiment.

As is clear from the comparison between FIG. 8 and FIG. 2, to the vehicle display device 19, the touch panels 22, 23, and 24 are connected, and the speakers 25, 26, 27, and 28 are connected.

Further, as is clear from the comparison between FIG. 8 and FIG. 2, the memory 110 stores a control program 114A instead of the control program 114.

The control program 114A is an example of the “program”.

The control program 114A is a program that makes the processor 100 function as the passenger detection unit 105, the traveling state detection unit 106, and a display control unit 107A.

The display control unit 107A displays the recommendation screen G by each of the touch panels 13, 22, 23, and 24.

When the passenger P for whom the preference information J3 is not stored in the memory 110 is included in the passengers P detected by the passenger detection unit 105, the display control unit 107A displays the first recommendation screen G1 by each of the touch panels 13, 22, 23, and 24.

When the preference information J3 of all the passengers P detected by the passenger detection unit 105 is stored in the memory 110, the display control unit 107A displays the second recommendation screen G2 by each of the touch panels 13, 22, 23, and 24. In this case, the display control unit 107A sets the display priority of the content for each of the touch panels 13, 22, 23, and 24, and displays the second recommendation screen G2 based on the set display priority of the content.

More specifically, the display control unit 107A sets the display priority of the content for the passenger P (hereinafter referred to as a “target passenger”) seated in a corresponding seat to be higher than the display priority of the content for the passengers P different from the target passenger for each of the touch panels 13, 22, 23, and 24. Then, the display control unit 107A displays the content based on the set display priority of the content for each of the touch panels 13, 22, 23, and 24.

For the touch panel 13, the display control unit 107A sets the display priority of the content to be set for the passenger P seated in the driver's seat 10A to be higher than the display priority of the content to be set for the passengers P seated in the seats other than the driver's seat 10A. Thus, for example, when the passengers P1, P2, P3, and P4 are detected as illustrated in FIG. 1, in the second recommendation screen G2 displayed by the touch panel 13, the content for the passenger P1 is displayed above the content for the other passengers P, and the content for the passenger P2 is displayed above the content for the passengers P3 and P4 on one screen related to one content distribution source.

For the touch panel 22, the display control unit 107A sets the display priority of the content to be set for the passenger P seated in the front passenger seat 10B to be higher than the display priority of the content to be set for the passengers P seated in the seats other than the front passenger seat 10B. Thus, for example, when the passengers P1, P2, P3, and P4 are detected as illustrated in FIG. 1, in the second recommendation screen G2 displayed by the touch panel 22, the content for the passenger P2 is displayed above the content for the other passengers P, and the content for the passenger P1 is displayed above the content for the passengers P3 and P4 on one screen related to one content distribution source.

For the touch panel 23, the display control unit 107A sets the display priority of the content to be set for the passenger P3 seated in the rear right seat 10C to be higher than the display priority of the content to be set for the passengers P seated in the seats other than the rear right seat 10C. Thus, for example, when the passengers P1, P2, P3, and P4 are detected as illustrated in FIG. 1, in the second recommendation screen G2 displayed by the touch panel 23, the content for the passenger P3 is displayed above the content for the other passengers P, the content for the passenger P1 is displayed above the content for the passengers P2 and P4, and the content for the passenger P2 is displayed above the content for the passenger P4 on one screen related to one content distribution source.

For the touch panel 24, the display control unit 107A sets the display priority of the content to be set for the passenger P4 seated in the rear left seat 10D to be higher than the display priority of the content to be set for the passengers P seated in the seats other than the rear left seat 10D. Thus, for example, when the passengers P1, P2, P3, and P4 are detected as illustrated in FIG. 1, in the second recommendation screen G2 displayed by the touch panel 24, the content for the passenger P4 is displayed above the content for the other passengers P, the content for the passenger P1 is displayed above the content for the passengers P2 and P3, and the content for the passenger P2 is displayed above the content for the passenger P3 on one screen related to one content distribution source.

Note that the display control unit 107A may set the display priority of the content as follows for each of the touch panels 13, 22, 23, and 24. That is, the display control unit 107A may set the display priority of the content to be set for the other passengers P for whom the preference information J3 similar to the preference information J3 of the target passenger is stored in the memory 110 to be next highest after the display priority of the content to be set for the target passenger.

In the present embodiment, the preference information J3 similar to the preference information J3 of the target passenger is the preference information J3 indicating the coinciding kind of the content and the predetermined number or more (for example, two or more) of the categories of the content that coincide with the categories of the content indicated by the preference information J3 of the target passenger.

For example, when the passengers P1, P2, P3, and P4 are detected as illustrated in FIG. 1 and the preference information J3 of the passenger P3 is similar to the preference information J3 of the passenger P4, for the touch panel 24, the display control unit 107A sets the display priority of the content to be set for the passenger P3 to be next highest after the display priority of the content to be set for the passenger P4. Thus, in the second recommendation screen G2 displayed by the touch panel 24, the content for the passenger P4 is displayed above the content for the other passengers P, the content for the passenger P3 is displayed above the content for the passengers P1 and P2, and the content for the passenger P1 is displayed above the content for the passenger P2 on one screen related to one content distribution source.

Next, the operation of the vehicle display device 19 of the present embodiment will be described with reference to FIG. 5.

The vehicle display device 19, after performing steps SA1 and SA2, skips step SA3 and proceeds to step SA4, then performs either step SA5 or step SA6. In step SA6 of the present embodiment, as described above, the display control unit 107A displays the recommendation screen G on each of the touch panels 13, 22, 23, and 24.

Next, the operation of the vehicle display device 19 of the present embodiment will be described with reference to FIG. 6.

When the display of the first recommendation screen G1 is started, the vehicle display device 19 performs step SB1, and if an affirmative determination is made in step SB1, performs step SB2. In step SB2 of the present embodiment, the display control unit 107A displays the recommendation screen G by each of the touch panels 13, 22, 23, and 24 as described above.

When one icon image IC is selected by a touch operation on the recommendation screen G displayed by the touch panel 13, the content output unit 104 outputs the content corresponding to the selected icon image IC by at least one of the touch panel 13 and the speaker 25.

In addition, when one icon image IC is selected by a touch operation on the recommendation screen G displayed by the touch panel 22, the content output unit 104 outputs the content corresponding to the selected icon image IC by at least one of the touch panel 22 and the speaker 26.

Further, when one icon image IC is selected by a touch operation on the recommendation screen G displayed by the touch panel 23, the content output unit 104 outputs the content corresponding to the selected icon image IC by at least one of the touch panel 23 and the speaker 27.

Further, when one icon image IC is selected by a touch operation on the recommendation screen G displayed by the touch panel 24, the content output unit 104 outputs the content corresponding to the selected icon image IC by at least one of the touch panel 24 and the speaker 28.

### 3. Other Embodiments

The embodiments described above merely indicate one aspect and arbitrary modifications and applications are possible.

In the embodiments described above, the case of a 4-seater vehicle 1 is exemplified. However, a passenger capacity of the vehicle 1 is not limited to four.

While a four-wheel vehicle 1 is exemplified in the embodiments described above, the number of wheels of the vehicle 1 is not limited to four.

While the touch panels 13, 22, 23, and 24 are exemplified as the “display unit” in the embodiments described above, the “display unit” is not limited to the touch panel, and may be a display that is operable with an operation key or the like without having a touch operation function.

While the vehicle display device 19 is not provided with the “display unit” in the embodiments described above, the vehicle display device 19 may be provided with the “display unit”.

While the icon images IC are lined up in the left-right direction of the recommendation screen G in the embodiments described above, a line-up direction of the icon images IC is not limited to the left-right direction and may be the up-down direction.

In the embodiments described above, the traveling state detection unit 106 detects the traveling state of the vehicle 1 based on a detection result of the shift position sensor 21. In another embodiment, a vehicle speed sensor may be provided in the vehicle 1 and the traveling state detection unit 106 may detect the traveling state of the vehicle 1 by the vehicle speed sensor.

In the embodiments described above, the passenger P is detected from the photographed images of the cameras 15, 17 and 18. In another embodiment, the passenger detection unit 105 may detect the passenger P by a method other than the photographed images of the cameras 15, 17 and 18. For example, when who is to get on is input to the vehicle display device 19 at the time of getting on, the passenger detection unit 105 may detect the passenger P by the input. Further, in another embodiment, when a microphone that collects voice of the passenger P is provided in the vehicle 1, the passenger detection unit 105 may detect the passenger P based on the number of pieces and kinds of the voice collected by the microphone. Further, in another embodiment, the passenger P seated in the driver's seat 10A may be detected by a FOB key.

In the embodiments described above, the seated position of the passenger P is detected from the photographed images of the cameras 15, 17 and 18. In another embodiment, the passenger detection unit 105 may detect the seated position of the passenger P by a method other than the photographed images of the cameras 15, 17 and 18. For example, when who is to sit in which seat is input to the vehicle display device 19 at the time of getting on, the passenger detection unit 105 may detect the passenger P by the input. Further, in another embodiment, the seated position of the passenger P may be detected based on the voice of the passenger P and a position of the microphone that most strongly collects the sound of the passenger P.

In the embodiments described above, the state of the passenger P is detected from the photographed images of the cameras 15, 17 and 18. In another embodiment, the passenger detection unit 105 may detect the state of the passenger P by a method other than the photographed images of the cameras 15, 17 and 18. For example, when the vehicle display device 19 periodically obtains biological data of the passenger P, the passenger detection unit 105 may detect the state of the passenger P by the biological data of the passenger P.

In the embodiments described above, the three application programs for utilizing the content are installed in the vehicle display device 19. In another embodiment, two or fewer or four or more application programs may be installed in the vehicle display device 19.

The processor 100 may be formed of a plurality of processors, or may be formed of one processor. The processor 100 may be hardware programmed to realize the functional units described above. In this case, the processors are formed of an ASIC (Application Specific Integrated Circuit) and an FPGA (Field Programmable Gate Array), for example.

Further, the configuration of the units of the vehicle 1 illustrated in FIG. 1 are only examples, and a specific mounting form is not limited in particular. That is, hardware individually corresponding to each unit does not need to be mounted, and it is also possible that one processor realizes functions of the respective units by executing a program. In addition, some of the functions realized by software in the embodiments described above may be hardware, or some of the functions realized by hardware may be realized by software.

Step units of the operation illustrated in FIG. 5 and FIG. 6 are divided according to main processing contents, and the present invention is not limited by a dividing method or a name of a processing unit. Division into further more step units may be performed according to the processing contents. Division may be also performed such that one step unit includes further more processing. Furthermore, the order of steps may be appropriately changed without interfering with the gist of the present invention.

Further, when a method of controlling the vehicle display device 19 described above is realized using the processor 100, the program to be executed by the processor 100 can be configured in a form of a recording medium or a transmission medium that transmits the program. That is, the control program 114 can be realized in a state of recording the control program 114 in a portable information recording medium. While examples of the information recording medium include a magnetic recording medium such as a hard disk, an optical recording medium such as a CD, and a semiconductor storage device such as a USB (Universal Serial Bus) memory and an SSD (Solid State Drive), other recording media can also be used.

### 4. Configurations Supported by Embodiments Described Above

The embodiments described above support the following configurations.

(Configuration 1) A vehicle display device including: a display control unit configured to recommend content by displaying the content available in a vehicle by a display unit installed inside the vehicle; a passenger detection unit configured to detect a passenger riding in the vehicle; and a storage unit configured to store preference information indicating a preference of the content for each passenger of the vehicle, wherein the display control unit varies a display mode of the content depending on whether or not the preference information corresponding to the passenger detected by the passenger detection unit is stored in the storage unit.

According to the vehicle display device of configuration 1, since the display mode of the content is made different depending on whether or not the preference information for the detected passenger is stored, the content can be recommended in consideration of the fact that the passenger whose content preference is unknown may be included in the passengers of the vehicle. Thus, the content can be appropriately recommended to the passengers of the vehicle.

(Configuration 2) The vehicle display device according to configuration 1, wherein, when the passenger detection unit detects a plurality of passengers and the preference information of all the passengers detected by the passenger detection unit is stored in the storage unit, the display control unit displays the content based on the corresponding preference information for each passenger detected by the passenger detection unit.

According to the vehicle display device of configuration 2, since the content based on the preference information can be recommended for each passenger when the preference of the content can be recognized regarding all the passengers of the vehicle, the appropriate content can be recommended for each passenger.

(Configuration 3) The vehicle display device according to configuration 2, wherein the passenger detection unit detects a seated position of the passenger for each detected passenger, and the display control unit sets display priority of the content for each passenger detected by the passenger detection unit based on the seated position of the passenger detected by the passenger detection unit, and displays the content based on the set display priority of the content.

According to the vehicle display device of configuration 3, by setting the display priority of the content based on the seated position of the passenger, the content can be recommended in consideration of the seated position of the passenger. Thus, the content can be more appropriately recommended to the passenger of the vehicle.

(Configuration 4) The vehicle display device according to configuration 3, including a traveling state detection unit configured to detect a traveling state of the vehicle, wherein the display control unit sets the display priority of the content based on the traveling state of the vehicle detected by the traveling state detection unit.

The passenger who is likely to utilize the content may differ depending on the traveling state of the vehicle. For example, while a driver is less likely to utilize the content when the driver is driving, the passengers other than the driver are likely to utilize the content. Therefore, according to the vehicle display device of configuration 4, by setting the display priority of the content based on the traveling state of the vehicle, the content can be recommended in consideration of the traveling state of the vehicle so that the content can be recommended according to the passenger who is likely to utilize the content. Thus, the content can be more appropriately recommended to the passenger of the vehicle.

(Configuration 5) The vehicle display device according to configuration 3, wherein the display unit is installed for each seat in the vehicle, and the display control unit sets the display priority of the content to be set for a target passenger who is the passenger seated in a corresponding seat to be higher than the display priority of the content to be set for the passengers different from the target passenger for each display unit, and displays the content based on the set display priority.

When the plurality of display units are provided for the respective seats inside the vehicle, the passenger who utilizes the content at a certain display unit is likely to be the passenger seated in the seat corresponding to the certain display unit. Therefore, by preferentially displaying the content preferred by the target passenger, the vehicle display device of configuration 5 can recommend the content according to the passenger who is likely to utilize the content for each display unit. Thus, even when the display unit is installed for each seat, the content can be more appropriately recommended to the passenger of the vehicle.

(Configuration 6) The vehicle display device according to configuration 5, wherein the display control unit sets the display priority of the content to be set for the other passengers for whom the preference information similar to the preference information of the target passenger is stored in the storage unit to be next highest after the display priority of the content to be set for the target passenger.

According to the vehicle display device of configuration 6, in addition to the content preferred by the target passenger, the content preferred by the other passengers close to the preference of the target passenger can be displayed. Therefore, the number of pieces of the content to be recommended to the target passenger can be increased, the content that the target passenger may prefer can be recommended, and the target passenger can recognize what kind of content the other passengers prefer.

(Configuration 7) The vehicle display device according to any one of configuration 1 to configuration 6, wherein, when the passenger detection unit detects a plurality of passengers and the passenger for whom the preference information is not stored in the storage unit is included in the passengers detected by the passenger detection unit, the display control unit displays the content for all the passengers detected by the passenger detection unit.

According to the vehicle display device of configuration 7, when the passenger whose content preference is unknown is included in the passengers of the vehicle, the content for all the passengers can be displayed. Therefore, the content not preferred by the passenger whose content preference is unknown is not recommended by the display of the content to a specific passenger. Thus, even when the passenger whose content preference is unknown is included in the passengers of the vehicle, the content can be appropriately recommended to the passenger of the vehicle.

(Configuration 8) The vehicle display device according to configuration 7, wherein the display control unit displays the content without being based on the preference information.

According to the vehicle display device of configuration 8, it is possible to suppress the passenger whose content preference is unknown from recognizing what kind of content is the preferred content. Thus, even when the passenger whose content preference is unknown is included in the passengers of the vehicle, the content can be more appropriately recommended to the passenger of the vehicle.

(Configuration 9) The vehicle display device according to configuration 7 or configuration 8, wherein the passenger detection unit detects a state of the detected passenger, and when the passenger detection unit detects that the state of the passenger for whom the preference information is not stored in the storage unit is a predetermined state of not looking at the display unit, the display control unit displays the content based on the corresponding preference information for each passenger detected by the passenger detection unit.

According to the vehicle display device of configuration 9, the content can be appropriately recommended in consideration of the state of the passenger whose content preference is unknown.

(Configuration 10) A method of controlling a vehicle display device, the method including: storing preference information indicating a preference of content available in a vehicle for each passenger of the vehicle; detecting a passenger riding in the vehicle; recommending the content by displaying the content by a display unit installed inside the vehicle; and varying a display mode of the content depending on whether or not the preference information corresponding to the detected passenger is stored, in display of the content.

According to the method of controlling the vehicle display device of configuration 10, an effect similar to that of the vehicle display device of configuration 1 is accomplished.

(Configuration 11) A non-transitory computer-readable storage medium storing a program that makes a processor of a vehicle display device including a storage unit configured to store preference information indicating a preference of content available in a vehicle for each passenger of the vehicle function as a display control unit configured to recommend the content by displaying the content by a display unit installed inside the vehicle and a passenger detection unit configured to detect a passenger riding in the vehicle, wherein the display control unit varies a display mode of the content be different depending on whether or not the preference information corresponding to the passenger detected by the passenger detection unit is stored in the storage unit.

According to the program of configuration 11, the effect similar to that of the vehicle display device of configuration 1 is accomplished.

### REFERENCE SIGNS LIST

1 . . . vehicle, 2 . . . content distribution server, 10A . . . driver's seat, 10B . . . front passenger seat, 10C . . . rear right seat, 10D . . . rear left seat, 11A . . . right front door, 11B . . . left front door, 11C . . . right rear door, 11D . . . left rear door, 11E . . . tailgate, 12 . . . dashboard, 13 . . . touch panel (display unit), 14 . . . speaker, 15 . . . camera, 16 . . . shift lever, 17 . . . camera, 18 . . . camera, 19 . . . vehicle display device, 20 . . . communication device, 21 . . . shift position sensor, 22 . . . touch panel (display unit), 23 . . . touch panel (display unit), 24 . . . touch panel (display unit), 25 . . . speaker, 26 . . . speaker, 27 . . . speaker, 28 . . . speaker, 100 . . . processor, 101 . . . first content output unit, 102 . . . second content output unit, 103 . . . third content output unit, 104 . . . content output unit, 105 . . . passenger detection unit, 106 . . . traveling state detection unit, 107 . . . display control unit, 110 . . . memory (storage unit), 111 . . . first APP, 112 . . . second APP, 113 . . . third APP, 114 . . . control program (program), 114A . . . control program (program), 115 . . . passenger DB, 1000 . . . content distribution system, A1 . . . list display area, A2 . . . list display area, G . . . recommendation screen, G1 . . . first recommendation screen, G2 . . . second recommendation screen, IC . . . icon image, J1 . . . face feature amount information, J2 . . . passenger identification information, J3 . . . preference information, J4 . . . first content related information, J41 . . . name information, J5 . . . second content related information, J51 . . . recommendation destination information, NW . . . network, P, P1, P2, P3, P4 . . . passenger.

1. A vehicle display device comprising:
a display control unit configured to recommend content by displaying the content available in a vehicle by a display unit installed inside the vehicle;
a passenger detection unit configured to detect a passenger riding in the vehicle; and
a storage unit configured to store preference information indicating a preference of the content for each passenger of the vehicle,
wherein the display control unit varies a display mode of the content depending on whether or not the preference information corresponding to the passenger detected by the passenger detection unit is stored in the storage unit.

2. The vehicle display device according to claim 1,
wherein, when the passenger detection unit detects a plurality of passengers and the preference information of all the passengers detected by the passenger detection unit is stored in the storage unit,
the display control unit displays the content based on the corresponding preference information for each passenger detected by the passenger detection unit.

3. The vehicle display device according to claim 2,
wherein the passenger detection unit detects a seated position of the passenger for each detected passenger, and
the display control unit sets display priority of the content for each passenger detected by the passenger detection unit based on the seated position of the passenger detected by the passenger detection unit, and displays the content based on the set display priority of the content.

4. The vehicle display device according to claim 3, comprising:
a traveling state detection unit configured to detect a traveling state of the vehicle,
wherein the display control unit sets the display priority of the content based on the traveling state of the vehicle detected by the traveling state detection unit.

5. The vehicle display device according to claim 3,
wherein the display unit is installed for each seat in the vehicle, and
the display control unit sets the display priority of the content to be set for a target passenger who is the passenger seated in a corresponding seat to be higher than the display priority of the content to be set for the passengers different from the target passenger for each display unit, and displays the content based on the set display priority.

6. The vehicle display device according to claim 5,
wherein the display control unit sets the display priority of the content to be set for other passengers for whom the preference information similar to the preference information of the target passenger is stored in the storage unit to be next highest after the display priority of the content to be set for the target passenger.

7. The vehicle display device according to claim 1,
wherein, when the passenger detection unit detects a plurality of passengers and the passenger for whom the preference information is not stored in the storage unit is included in the passengers detected by the passenger detection unit,
the display control unit displays the content for all the passengers detected by the passenger detection unit.

8. The vehicle display device according to claim 7,
wherein the display control unit displays the content without being based on the preference information.

9. The vehicle display device according to claim 7,
wherein the passenger detection unit detects a state of the detected passenger, and
when the passenger detection unit detects that the state of the passenger for whom the preference information is not stored in the storage unit is a predetermined state of not looking at the display unit,
the display control unit displays the content based on the corresponding preference information for each passenger detected by the passenger detection unit.

10. A method of controlling a vehicle display device, the method comprising:
storing preference information indicating a preference of content available in a vehicle for each passenger of the vehicle;
detecting a passenger riding in the vehicle;
recommending the content by displaying the content by a display unit installed inside the vehicle; and
varying a display mode of the content depending on whether or not the preference information corresponding to the detected passenger is stored, in display of the content.

11. A non-transitory computer-readable storage medium storing a program that makes
a processor of a vehicle display device including a storage unit configured to store preference information indicating a preference of content available in a vehicle for each passenger of the vehicle function as
a display control unit configured to recommend the content by displaying the content by a display unit installed inside the vehicle and
a passenger detection unit configured to detect a passenger riding in the vehicle,
wherein the display control unit varies a display mode of the content depending on whether or not the preference information corresponding to the passenger detected by the passenger detection unit is stored in the storage unit.
